(19) United States
(12) Patent Application Publication
(10) Pub. No.: US 2025/0057145 A1
(43) Pub. Date: Feb. 20, 2025

(54) Plant Wraps for Killing Individual Weeds and Method of Use

(71) Applicant: Michael C. LaRocco, Sewickley, PA (US)

(72) Inventor: Michael C. LaRocco, Sewickley, PA (US)

(21) Appl. No.: 17/545,938

(22) Filed: Dec. 8, 2021

Related U.S. Application Data
(60) Provisional application No. 63/122,696, filed on Dec. 8, 2020.

(51) Int. Cl. A01M 21/04

(52) U.S. Cl. CPC A01M 21/043

(57) ABSTRACT

An applicator for wrapping about an individual weed and applying a liquid herbicide to said individual weed. The applicator is comprised of an outer metal layer and an inner fabric layer soaked with a liquid herbicide. The two layers may be joined together by adhesive means, mechanical means or both. A method of use is also disclosed.

### REFERENCE TO RELATED APPLICATIONS

This application is a perfection of U.S. Provisional Application No. 63/122,696, filed on Dec. 8, 2020, the disclosure of which is fully incorporated by reference herein.

### STATEMENT OF GOVERNMENT INTEREST

Not Applicable

### STATEMENT AS TO RIGHTS TO INVENTIONS MADE UNDER FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

This invention relates to the general field of weed killing, particularly killing individual weeds in a crowded garden setting amidst flowers or other “good” plants.

Many specialty chemicals (herbicides) are available for eradicating unwanted plants. Some of these chemicals are applied, often by spraying directly onto weeds and the like, then absorbed through the leaves and stems and carried down to the roots where they kill the entire plant. Such chemicals are desirable in horticulture because they can kill an undesired plant more easily than trying to uproot it. Some weeds only spread faster when their tops are pulled off. When the weed is growing in a bed of desirable flowers/vegetables or other plants, it is helpful if the roots of the good plants do not have to be disturbed by uprooting the unwanted weed.

Unfortunately, the good plants may be as susceptible to the herbicide as the weed. Consequently, the usual method of spraying herbicide on the weed, even focused spraying, may not be feasible. This is especially true under windy conditions. Furthermore, certain weeds may have waxy surfaces that are relatively impermeable to most herbicide preparations. Many of these specialty chemicals may be quite expensive and somewhat toxic if the spray is inhaled.

### (2) Description of Related Art—None at This Time

### BRIEF SUMMARY OF THE INVENTION

Accordingly, it is an object of the invention to provide means for selectively

applying certain materials such as herbicides to plants that avoids spraying. It is another object that the invention protect the user from contact with the materials to be applied.

It is yet another object that the applicator means enhance the absorption of the materials by the selected plants.

The invention comprises a special applicator (fabric-based) wipe that is provided with a liquid weed killer (either a natural formula or already available commercial composition). That fabric based “liner” would be combined with a foil backing to: (i) keep the liner (or “towel portion”) moist with herbicide; (ii) assist with more readily wrapping the combination about a desired location of the individual weed to be targeted for removal (i.e., either its stem or leaves-depending on the type of plant needing to be eradicated); and (iii) keep the applied wrap from too easily being blown off/away. The “outer” foil portion and “inner” towel portion can be joined together by one of various means: adhesive (including glue or tape), and/or mechanically (with pressured wrap-around edges or the like). The invention, tentatively to be marketed in a box or other dispenser under the brand: WEED WRAPS™, is meant to provide for highly localized herbicide applications to an individual, undesirable plant growth.

### BRIEF DESCRIPTION OF THE DRAWING(S)

Further features, objectives and advantages will become clearer when reviewing the following description of preferred embodiments made with reference to the accompanying photographs in which to one embodiment of this invention;

FIG. 1 is a side sectional view of two representative weed wraps according to one embodiment of this invention stacked one atop the other and separated with a release sheet for preventing them from sticking together;

FIG. 2 is a cross-sectional view of an open box of weed wraps with release sheets between adjacent sheets;

FIG. 3 is a top plan view of a roll of weed wraps showing perforations between adjacent sheets and a release sheet between roll layers;

FIG. 4 is a side sectional view of only one individual weed wrap like that shown in FIG. 1 but with a removable protective release sheet over the adhesive inner layer for manually removing prior to installing and crimping about an undesired weed;

FIG. 5 is a top plan view showing a portion of the fabric component, or underside, to the weed wrap depicted in FIG. 1;

FIG. 6 is a top plan view of the outer foil component to the weed wrap at FIG. 1;

FIG. 7 is a top plan view of one embodiment of the invention applied about an intermediate stem portion of a single weed; and

FIG. 8 is a top plan view of another weed wrap applied to another, more leafy weed.

### DESCRIPTION OF PREFERRED EMBODIMENTS

In the various embodiments, common elements are commonly numbered though in the next hundred series.

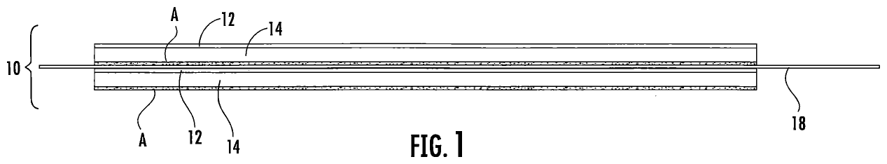

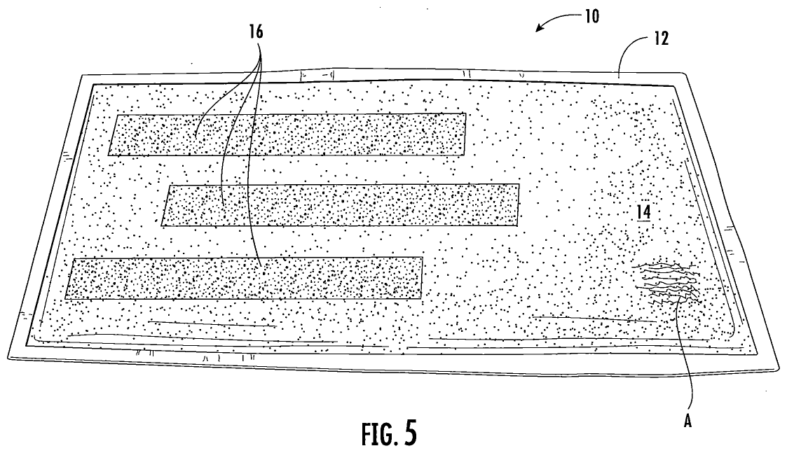

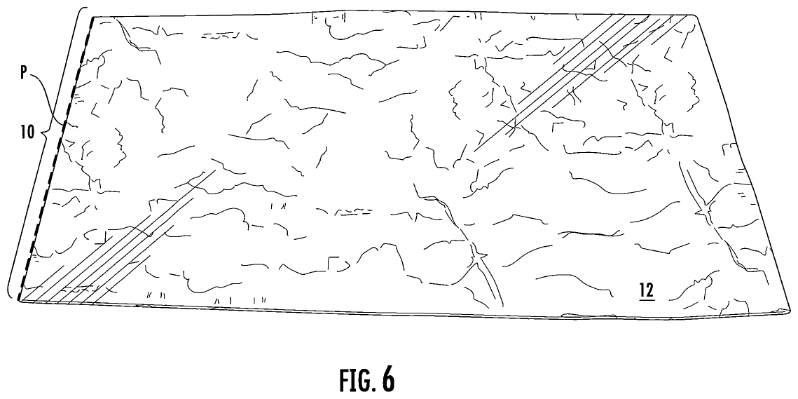

Referring now to FIGS. 1 and 5-6, there is shown a first embodiment of weed wrap, generally 10, comprising an outer, vapor impermeable layer 12, and an inner, fabric layer 14 onto which a weed-killing liquid has been imparted as shown by the plurality of arrows 16. Ideally, the inner layer 14 should be pre-soaked with weed-killing liquid 16 which may or may not have some adhesive qualities.

Preferably, adjacent sheets of weed wraps may be stacked, one atop another, with a release sheet 18 between. Removal of the release sheet 18 would be needed before the weed-killing liquid layer is sufficiently exposed for contacting with the undesired plant/weed.

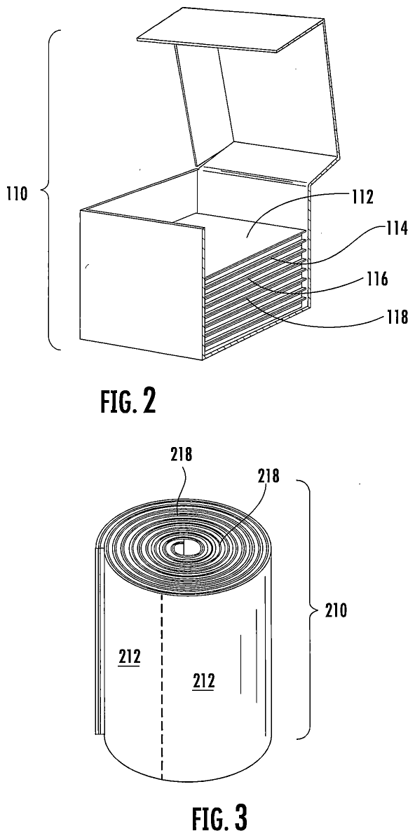

In a first variation, FIG. 2, a collection of weed wraps 110 can be kept in a watertight box, canister or container (partially shown in cross-section). Three representative wraps are shown, with their respective components, outer crimping layer 112, inner fabric layer 114 and weed-killing layer 116, with a release sheet 118 between adjacent layers

A second variation, FIG. 3, shows a plurality of weed wrap sheets 210, on a roll R, not unlike a cylindrical package of baby or other hygiene wipes. Similar to FIG. 2, these wraps consist of individual components, outer crimping layer 212, inner fabric 214, weed killer layer 216 and a non-sticking, release sheet 218 between adjacent roll layers. FIG. 3 also shows the extent to which adjacent sheets may be separated, i.e., via a series of. sheet perforations P.

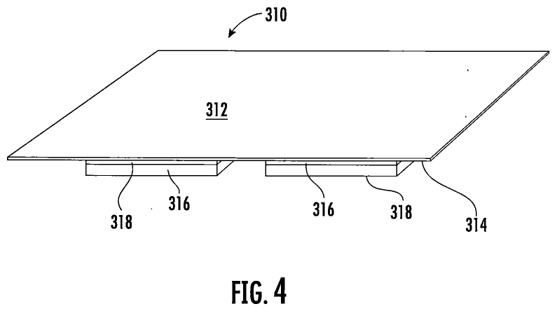

FIG. 4 shows a third variation of individual weed wrap sheet 310, with its similar outer layer 312, inner fabric 314 and weed killer layer shown as a plurality of applied adhesive strips 216. To best protect this combination from sticking prematurely, at least the undersides to strips 216 are covered with release sheets 318. They may be used as individual strip covers, or as one enlarged release sheet covering the entire underside to weed wrap 310.

Preferably, the weed wraps will enable wicking from a lower base of extra liquid in which a roll of wraps will rest. The wraps themselves can be individualized, or kept on one continuous roll with perforations P (or pre-tear points) between adjacent sheets.

Representative liquids include an already marketed herbicide, a customized blend and combinations of natural weed killers like vinegar and salt(s).

The inner fabric layer is meant to HOLD the liquid directly against the plant/weed W about which the invention is wrapped. Outer “foil” layer 12 provides sufficient rigidity so that wrap 10 stays crimped, or crumpled about or otherwise more permanently adhered to the weed W . . . without the express need for adding an adhesion layer (separate from the week killing layer), and furthermore, without being easily knocked off and/or accidentally blown away. Together, this invention provides both mechanical and physical means for securing about individual plants that the consumer/user wants to get rid of without damaging (or negatively impacting) adjacent desired plants/flowers/vegetables, etc.

In certain cases, the plant may have a surface that is waxy or for some other reason is resistant to penetration of the treating liquid. So, optionally, one or more abrasive pads or areas A on a portion of inner wipe layer 14 may be provided for first scratching an outermost surface of the weed/plant W before being fully encased around its stem S or lowermost leaves L, so that liquids from the pre-soaked interiors may better contact with (or more easily penetrate) that plant's scarified surface.

Alternatively, abrasive areas A may be incorporated into each individualized sheet. They may be any of a variety of abrasive elements well known in the industry such as emery cloth, sandpaper or a fibrous abrasive pad. The abrasive elements are so positioned relative to the wrap's interior such that that a natural grasping and slight upward pull on the plant will move the abrasive element over a plant surface followed by a subsequent natural positioning of the liquid soaked, interior layer thereagainst right after.

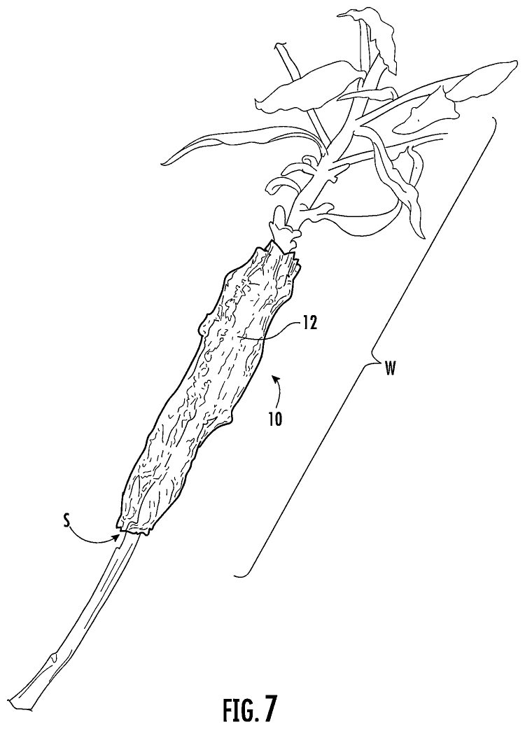

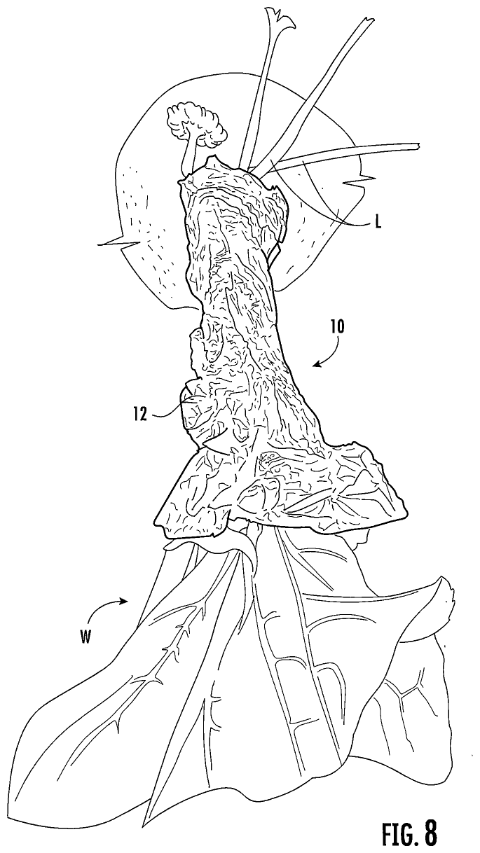

FIGS. 7 and 8 illustrate embodiments of this invention as installed on the stem S (FIG. 7) or about the lowermost leaves L (FIG. 8) of an undesired plant growth. i.e., weed W.

Having described the best modes currently known for practicing this system and method, it is to be understood that the scope of this invention may be further described by the attached claims

### SEQUENCE LISTING

Not applicable

What is claimed is:

1. An applicator for wrapping about an individual weed and applying a liquid herbicide to said individual weed, said applicator comprising an outer metal layer and an inner fabric layer loaded with a liquid herbicide, said outer layer being joined to said inner layer by adhesive means, mechanical means or both.

2. The applicator of claim 1 wherein the outer metal layer is a thin foil product.

3. The applicator of claim 2 wherein the foil product is an aluminum alloy.

4. The applicator of claim 2 wherein the liquid herbicide is a natural blend that includes vinegar.

5. The applicator of claim 2, which further includes a waterproof container for holding a plurality of applicators in a reservoir with at least some liquid herbicide.

6. The applicator of claim 5 wherein the plurality of applicators is stored together on a continuous roll.

7. The applicator of claim 6 wherein the continuous roll includes perforations between adjacent applicators.

8. The applicator of claim 2, which further includes a section of abrasive material.

9. The applicator of claim 1, which further includes a release sheet component for preventing adjacent applicators from sticking together when horizontally stacked before use.

10. The applicator of claim 1, which is adapted for wrapping about a stem section of the individual weed.

11. The applicator of claim 1, which is adapted for wrapping about one or more lower leaves of the individual weed.

12. A method for selectively applying liquid to a surface of an unwanted plant, the method comprising the steps of:
a) providing a weed wrap having an inner fabric component that is pre-soaked with a liquid herbicide and an outer metal component for securing to the surface of the unwanted plant;
b) sufficiently soaking the inner fabric component with the liquid herbicide; and
c) wrapping the outer metal component of the weed wrap about one or more sections of the unwanted plant.

13. The method of claim 12 wherein the weed wrap includes an abrasive component and the method further comprises the step of scouring the unwanted plant with the abrasive component of the weed wrap prior to step c).

14. The method of claim 12 wherein the liquid herbicide is a natural week killer that includes a vinegar element.

15. The method of claim 12 wherein a plurality of weed wraps is stored together in a waterproof container for holding until removed for use.

16. The method of claim 15 wherein the container includes a release sheet between adjacent weed wraps.
plurality of weed wraps is stored together on a continuous roll.

17. The method of claim 15 wherein the container is substantially cylindrical and the

18. The method of claim 17 wherein each of the plurality of weed wraps is perforated on at least one lateral edge for separating from the continuous roll prior to sue.
